(19) United States
(12) Patent Application Publication
(10) Pub. No.: US 2003/0137957 A1
(43) Pub. Date: Jul. 24, 2003

(54) Radio transmitting and receiving device and radio communication system

(75) Inventors: Yoshikazu Kakura, Tokyo (JP); Akihisa Ushirokawa, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/348,761

(22) Filed: Jan. 23, 2003

(30) Foreign Application Priority Data
Jan. 24, 2002 (JP) 2002-015438

(51) Int. Cl. H04B 7/216

(52) U.S. Cl. 370/335; 370/342

(57) ABSTRACT

A radio communication system having a transmitting device and a receiving device is provided which is capable of avoiding occurrence of non-communicable areas even when a number of frequency channels is insufficient or even when base stations cannot be placed among sufficiently short intervals and of improving an average throughput in the base stations and the radio communication system. When channel quality exceeds a predetermined level, radio signals are transmitted and received, according to an orthogonal frequency division multiplexing method. In contrast, when the channel quality becomes degraded, by performing code spreading and despreading by using a spreading rate being predetermined so that, as the channel quality becomes degraded a larger value is selected, information is transmitted and received.

### BACKGROUND OF THE INVENTION

1. Field of the Invention

The present invention relates to a radio transmitting and receiving device and a radio communication system providing multipath-proof performance.

The present application claims priority of Japanese Patent Application No. 2002-015438 filed on Jan. 24, 2002, which is hereby incorporated by reference.

2. Description of the Related Art

As a conventional radio transmission method providing multipath-proof performance, an OFDM (Orthogonal Frequency Division Multiplexing) method in which a multi-carrier transmission is achieved by performing Fourier transformation, a multi-carrier CDMA (Code Division Multiple Access) in which a code is spread on ant anis of a frequency, and a multi-carrier DS —CDMA (Direct Sequence—Code Division Multiple Access) in which a code is spread on an axis of time are known.

First, a radio transmitting and receiving device using the OFDM method, out of these radio transmitting and receiving devices, will be described in “Modulation and Demodulation in Digital Radio Communication” (Yoichi Saito, The Institute of Electronics, Information and Communication Engineers, pp. 203-207, 1996) and shown in FIGS. 7A and 7B.

FIGS. 7A and 7B are schematic block diagrams showing, as a whole, configurations of the conventional radio transmitting and receiving device using the OFDM method. The conventional radio transmitting and receiving device is provided with a radio transmitting unit device) 301 as shown in FIG. 7A, and a radio receiving unit (device) 302 as shown in FIG. 7B.

As shown in FIG. 7A, the transmitting unit 301 includes a serial-parallel converting section 303, an inverse Fourier transforming section 204, and a guard interval adding section 305. Also, as shown in FIG. 7B, the receiving unit 302 includes a guard interval removing section 306, a Fourier transforming section 307, a parallel-serial converting section 308, and a demodulating section 309.

The serial-parallel converting section 303 in the transmitting unit 301 converts transmitted data S_{TDAT} being serial data into parallel data and outputs j-pieces (“j” is an integer being not less than 2) of inverse Fourier transforming input signals S_{IFFT} (1) to S_{IFFT} (j)

The inverse Fourier transforming section 304 performs inverse Fourier transformation on each of the inverse Fourier transforming input signals S_{IFFT} (1) to S_{IFFT} (j) output from the serial-parallel converting section 303 and outputs resulting inverse Fourier transformed output signals S_{IFFTO}.

The guard interval adding section 305 copies part of the inverse Fourier transformed output signal S_{IFFTO} output from the inverse Fourier transforming section 304 and adds the resulting copied signals to the inverse Fourier transformed output signal S_{IFFTO} as a guard interval (being also called a guard band or a guard time in some cases) and outputs them as a transmitting signal S_{TX}.

On the other hand, the guard interval removing section 306 in the receiving unit 302 removes the guard interval from a received signal S_{RX} and outputs the signal as a Fourier transforming input signal S_{FFTI}.

The Fourier transforming section 307 performs Fourier transformation on the Fourier transforming input signal S_{FFTI} output from the guard interval removing section 306 and outputs j-pieces of Fourier transformed output signals S_{FFTO} (1) to S_{SSTO} (j) being results from the Fourier transformation.

The parallel-serial converting section 308 converts the j-pieces of Fourier transformed output signals S_{FFTO} (1) to S_{SSTO} (j) output from the Fourier transforming section 307 into serial data and outputs demodulating section input signal S_{IDEM}.

The demodulating section 309 demodulates signals transmitted based on the demodulating section input signal S_{IDEM} output from the parallel-serial converting section 308 and outputs the demodulated signals as a receiving data signal S_{RDAT}.

It is know that, in the radio transmitting and receiving device using the OFDM method as described above, multi-carrier transmission providing a high spectrum efficiency can be made possible by performing inverse Fourier transformation on transmitting signals and by performing Fourier transformation on received signals. Moreover, by adding a guard interval to a transmitting signal, intersymbol interference caused by propagation of a multipath can be reduced.

Next, a radio transmitting and receiving device using the multi-carrier CDMA method and the multi-carrier DS-CDMA method is described in “Overview of Multi-carrier CDMA”, S. Hara., et al: IEEE Communication Magazine, pp. 127-129 (1997) and shown in FIGS. 8A and 8B and FIGS. 9A and 9B.

FIGS. 8A and 8B are schematic block diagrams showing, as a whole, configurations of the conventional radio transmitting and receiving device using the multi-carrier CDMA method. The conventional radio transmitting and receiving device is provided with a radio transmitting unit (device) 401 as shown in FIG. 8A, and a radio receiving unit (device) 402 as shown in FIG. 8B.

As shown in FIG. 8A, the transmitting unit 401 includes a serial-parallel converting section 403, a first data copying sections 404₁ to a j-th data copying section 404ⱼ, a first spreading section 405₁ to a j-th spreading section 405ⱼ, a code multiplexing section 406, an inverse Fourier transforming section 407, and a guard interval adding section 408. As shown in FIG. 8B, the receiving unit 402 includes a guard interval removing section 409, a Fourier transforming section 410, a despreading section 411, a parallel-serial converting section 412, and a demodulating section 413.

The serial-parallel converting section 403 in the transmitting unit 401 converts transmitted data S_{TDAT} being serial data into parallel data and outputs j-pieces (“j” is an integer being not less than 2) of parallel signals S_{PDAT} (1) to S_{PDAT} (j)

The first data copying sections 404₁ to the j-th data copying section 404ⱼ copy k-pieces (“k” is an integer being not less than 2) of each of the parallel data signals S_{PDAT} (1) to S_{PDAT} (j) output from the serial-parallel converting section 403 and outputs the copied signals as spreading section input signals S_{SPI1} (1) to S_{SPI1} (k) S_{SPI2} (1) to S_{SPI2} (k), . . . , S_{SPIj} (1) to S_{SPIj} (k) respectively.

The first spreading section 405₁ to the j-th spreading section 405ⱼ perform code spreading on each of the spreading section input signals S_{SPI1} (1) to S_{SPI1} (k), S_{SPI2} (1) to S_{SPI2} (k), . . . , S_{SPIj} (1) to S_{SPIj} (k) using an i-th (i=0, 1, . . . , k−1) spreading code on an axis of a frequency employed in the OFDM method and outputs spreading section input signals S_{SPO1} (1)—S_{SPO1} (k), S_{SPO2 (1)} to S_{SPO2} (k), . . . , S_{SPOj} (1) to S_{SPOj} (k) , respectively.

The code multiplexing section 406 performs multi-code multiplexing on each of the spreading section input signals S_{SPO1} (1)—S_{SPO1} (k), S_{SPO2} (1) to S_{SPO2} (k), . . . , S_{SPOj} (1) to S_{SPOj} (k) output from the first spreading section 405₁ to the j th spreading section 405ⱼ by using k-pieces of spreading codes intersecting at right angles and outputs :-pieces of inverse converting input signals S_{IFFT} (1) to S_{IFFT} (j).

The inverse Fourier transforming section 407 performs inverse Fourier transformation on each of the inverse Converting input signals S_{IFFT} (1) to S_{IFFT} (j) output from the code multiplexing section 406 and outputs inverse Fourier transforming input signals S_{IFFTO}.

The guard interval adding section 408 copies part of the inverse Fourier transforming input signal S_{IFFTO} output from the inverse Fourier transforming section 407 and adds the copied signals to the inverse Fourier transforming input signals S_{IFFTO} as a guard interval and outputs the resulting signal as a transmitting signal S_{TX}.

On the other hand, the guard interval removing section 409 in the receiving unit 402 removes the guard interval from a received signal S_{RX} and outputs the resulting signal as a Fourier transforming input signal S_{FFTI}.

The Fourier transforming section 410 performs Fourier transformation on the Fourier transforming input signal S_{FFTI} output from the guard interval removing section 409 and outputs j-pieces (“j” is an integer being not less than 2) of the Fourier transformed output signals S_{FFTO} (1) to S_{FFTO} (j).

The despreading section 411 performs despreading on each of the Fourier transformed output signals S_{FFTO} ( 1 ) to S_{FFTO} (j) output from the Fourier transforming section 410 on an axis of a frequency employed in the OFDM method by using k-pieces of spreading signals intersecting at right angles and outputs j-pieces of respread output signals S_{DSO} (1) to S_{DSO} (j), respectively.

The parallel-serial converting section 412 converts j-pieces of respread output signals S_{DSO} (1) to S_{DSO} (1) output from the despreading section 411 into serial data and outputs a demodulating section input signal S_{IDEM}.

The demodulating section 413 demodulates signals transmitted based on the demodulating section input signal S_{IDEM} output from the parallel-serial converting section 412 and outputs the demodulated signals as a receiving data signal S_{RDAT}.

In the radio transmitting and receiving device using the multi-carrier CDMA method as described above, multi-carrier transmission providing a high spectrum efficiency can be made possible by performing inverse Fourier transformation on the transmitting signals and by performing Fourier transformation on the received signals. Moreover, by adding a guard interval to the transmitting signal, intersymbol interference caused by propagation of a multipath can be reduced. Furthermore, by performing code spreading on an axis of a frequency employed in the OFDM method, communications making a gain in code spreading can be made possible.

FIGS. 9A and 9B are schematic block diagrams showing, as a whole, configurations of the conventional radio transmitting and receiving device using the multi-carrier DS-CDMA method. The conventional radio transmitting and receiving device is provided with a radio transmitting unit (device) 501 as shown in FIG. 9A, and a radio receiving unit (device) 502 as shown in FIG. 9B.

As shown in FIG. 9A, the transmitting unit 501 includes a serial-parallel converting section 503, a first spreading section 504₁ to a j-th spreading section 504ⱼ, a code multiplexing section 505, an inverse Fourier transforming section 506, and a guard interval adding section 507. Also, as shown in FIG. 9B, the receiving unit 502 includes a guard interval removing section 508, a Fourier transforming section 509, a despreading section 510, a parallel-serial converting section 511, and a demodulating section 512.

The serial-parallel converting section 503 in the transmitting unit 501 converts transmitting data S_{TDAT} being serial data into parallel data and outputs jk-pieces (“j” and “k” are integers being not less than 2) of parallel data signals S_{FDAT} (1) to S_{PDAT} (jk).

The first spreading section 504₁ to the j-th spreading section 504j perform code spreading on each of the parallel data signals S_{PDAT} (1) to S_{PDAT} (jk) output from the serial-parallel converting section 503 by using an i-th spreading code on an axis of time and outputs spreading section output signals S_{SPO} (1) to S_{SPO} (jk) each having a chip rate being 1/k times larger than that of each of the parallel data signals S_{PDAT} (1) to S_{PDAT} (jk).

The code multiplexing section 505 performs multi-code multiplexing on each of the spreading section output signals S_{SPO1} (1) to S_{SPOj} (jk) output from the first spreading section 504₁ to j-th spreading section 504j by using k-pieces of spreading codes intersecting at right angles and outputs j-pieces of inverse Fourier transforming input signals S_{IFFT} (1) to S_{IFFT} (j).

The inverse Fourier transforming section 506 performs inverse Fourier transformation on each of the inverse Fourier transforming input, signals S_{IFFT} (1) to S_{IFFT} (j) output from the code multiplexing section 505 and outputs inverse Fourier transformed output signal S_{IFFTO}

The guard interval adding section 507 copies part of the inverse Fourier transformed output signal S_{IFFTO} output from the inverse Fourier transforming section 506 and adds the copied signals to the inverse Fourier transformed output signal S_{IFFTO} as a guard interval and outputs the resulting signal as a transmitting signal S_{TX}.

On the other hand, the guard interval removing section 508 in the receiving unit 502 removes the guard interval from a received signal S_{RX} and outputs the resulting signal as Fourier transforming input signal S_{FFTI}.

The Fourier transforming section 509 performs Fourier transformation on the Fourier transforming input signal S_{FFTI} output from the guard interval removing section 508 and outputs j-pieces (“j” is an integer being not less than 2) of Fourier transformed output signals S_{FFTO} (1) to S_{FFTO} (j)

The despreading section 510 performs despreading on each of the Fourier transformed output signals S_{FFTO} (1) to S_{FFTO} (j) output from the Fourier transforming section 509 on an axis of time by using k-pieces of spreading codes intersecting at right angles and outputs j-pieces of despreading output signals S_{DSO} (1) to S_{DSO} (j).

The parallel-serial converting section 511 converts each of the j-pieces of despreading output signals S_{DSO} (1) to S_{DSO} (j) into serial data and outputs the converted data as a demodulating section input signal S_{IDEM}.

The demodulating section 512 demodulates signals transmitted based on the demodulating section input signal S_{IDEM} and outputs the demodulated signal as a receiving data signal S_{RDAT}.

It is known that, in the radio transmitting and receiving device using the DS-CDMA method as described above, multi-carrier transmission providing a high spectrum efficiency can be made possible by performing inverse Fourier transformation on transmitting signals and by performing Fourier transformation on received signals Moreover, by adding a guard interval to a transmitting signal, intersymbol interference caused by propagation of a multipath can be reduced. Furthermore, by performing code spreading on an axis of time employed in the OFDM method, communications making a gain in code spreading can be made possible.

However, the radio transmitting and receiving device using the OFDM method, out of the conventional radio transmitting and receiving devices, presents a problem in that, if a number of frequency channels is not sufficient, when such the radio transmitting and receiving device using the OFDM method is placed nearer a boundary among cells in multi-cell environments, its channel quality is degraded more, thus causing communications to become difficult Moreover, it has another problem in that, if a base station is not placed among sufficiently short intervals, a service area becomes very limited.

In contrast, in the radio transmitting and receiving device using the multi-carrier CDMA method or using the multi-carrier DS-CDMA method, since a gain can be made in code spreading, a communicable area can be expanded. However, if multi-code multiplexing is performed to achieve a data signaling rate being equivalent to that obtained in the OFDM method, signal power becomes weak per one code, which causes the gain in code spreading to be offset and therefore same problems as occurring in the radio transmitting and receiving device using the OFDM method arise. Moreover, still another problem arises in that, in environments in which propagation of a multipath occurs, orthogonality among codes is lost and transmitting and receiving performance is degraded.

### SUMMARY OF THE INVENTION

In view of the above, it is an object of the present invention to provide a radio communication system having a transmitting unit and a receiving unit being capable of avoiding an occurrence of non-communicable areas even when a number of frequency channels is not sufficient or even when a base station cannot be placed among sufficiently short intervals and of improving an average throughput as the base station and the radio communication system.

According to a first aspect of the present invention, there is provided a radio transmitting and receiving device including;

a transmitting unit to transmit radio signals, by using an orthogonal frequency division multiplexing method when channel quality exceeds a predetermined level, and by performing code spreading, using a spreading rate being preset so that, as the channel quality becomes degraded, a larger value as the spreading rate is selected, when the channel quality is less than the predetermined level; and

a receiving unit to demodulate received radio signals by detecting the channel quality from the received radio signals, by receiving the radio signals using the orthogonal frequency division multiplexing method when the channel quality exceeds a predetermined level and by performing despreading by using a spreading rate selected by the transmitting unit when the channel quality is less than the predetermined level.

In the foregoing, a preferable mode is one wherein the receiving unit outputs information about a signal-to-noise ratio as the channel quality.

Also, a preferable mode is one wherein the receiving unit outputs information about a signal-to-interference ratio as the channel quality.

Also, a preferable mode is one wherein the receiving unit outputs information about a ratio of a signal power to a sum of noise power and interference power as the channel quality.

Also, a preferable mode is one wherein the transmitting unit has a spreading rate selecting section to select 1 (one) as the spreading rate when the channel quality exceeds a predetermined level and to select a spreading rate a spreading rate, being a power of 2, which is predetermined according to the channel quality when the channel quality is less than the predetermined level.

Also, a preferable mode is one wherein the transmitting unit performs code spreading on an axis of a frequency by using a selected spreading rate when the channel quality is less than the predetermined level and wherein the receiving unit performs despreading on an axis of a frequency by using the spreading rate when the channel quality is less than the predetermined level.

Also, a preferable mode is one wherein the transmitting unit performs code spreading on an axis of time by using a selected spreading rate when the channel quality is less than the predetermined level and wherein the receiving unit performs despreading on an axis of time by using the spreading rate when the channel quality is less than the predetermined level.

Also, a preferable mode is one wherein the transmitting unit, when performing code multiplexing by using two or more types of codes, selects a multiplied spreading rate obtained by multiplying a spreading rate, to be selected when the code multiplexing is not performed, by a number of the types of codes to be multiplexed.

According to a second aspect of the present invention, there is provided a radio communication system including:

a transmitting device to transmit radio signals, by using an orthogonal frequency division multiplexing method when channel quality exceeds a predetermined level, and by performing code spreading, using a spreading rate being preset so that, as the channel quality becomes degraded, a larger value as the spreading rate is selected, when the channel quality is less than the predetermined level; and

a receiving device to demodulate received radio signals by detecting the channel quality from the received radio signals, by receiving radio signals using the orthogonal frequency division multiplexing method when the channel quality exceeds a predetermined level and by performing despreading by using a spreading rate selected by the transmitting device when the channel quality is less than the predetermined level.

In the foregoing second aspect, a preferable mode is one wherein the receiving device outputs information about a signal-to-noise ratio as the channel quality.

Also, a preferable mode is one wherein the receiving device outputs information about a signal-to-interference ratio as the channel quality

Also, a preferable mode is one wherein the receiving device outputs information about a ratio of a signal power to a sum of noise power and interference power as the channel quality.

Also, a preferable mode is one wherein the transmitting device has a spreading rate selecting section to select 1 (one) as the spreading rate when the channel quality exceeds the predetermined level and to select a spreading rate, being a power of 2, which is predetermined according to the channel quality when the channel quality is less than the predetermined level.

Also, a preferable mode is one wherein the transmitting device performs code spreading on an axis of a frequency by using a selected spreading rate when the channel quality is less than the predetermined level and wherein the receiving device performs despreading on an axis of a frequency by using the spreading rate when the channel quality is less than the predetermined level.

Also, a preferable mode is one wherein the transmitting device performs code spreading on an axis of time by using a selected spreading rate when the channel quality is less than the predetermined level and wherein the receiving device performs despreading on an axis of time by using the spreading rate when the channel quality is less than the predetermined level.

Also, a preferable mode is one wherein the transmitting device, when performing code multiplexing by using two or more types of codes, selects a multiplied spreading rate obtained by multiplying a spreading rate, to be selected when the code multiplexing is not performed, by a number of types of codes to be multiplexed.

Also, a preferable mode is one wherein the transmitting device is placed in each of base stations, wherein the receiving device is placed in each of terminal devices to receive information from the base stations, and wherein multi-cells are constructed in one cell reuse manner in which all the base stations carry out radio communications with the terminal devices using same frequencies.

Also, a preferable mode is one wherein the transmitting device is placed in each of base stations, wherein the receiving device is placed in each of terminal devices to receive information from the base stations, and wherein multi-cells are constructed in M (M is an integer being not less than 2) cell reuse manner in which all the base stations carry out radio communications with the terminal devices using M-types of frequencies.

Also, a preferable mode is one wherein the transmitting device is placed in each of base stations and each of terminal devices to receive information from the base stations, wherein the receiving device is placed in each of base stations and each of terminal devices, and wherein multi-cells are constructed in one cell reuse manner in which all the base stations carry out radio communications with the terminal devices by using same frequencies.

Also, a preferable mode is one wherein the transmitting device is placed in each of base stations and each of terminal devices to receive information from the base stations, wherein the receiving device is placed in each of base stations and each of terminal devices, and wherein multi-cells are constructed in M (M is an integer being not less than 2) cell reuse manner in which all the base stations carry out radio communications with the terminal devices by using M-types of frequencies.

According to a third aspect of the present invention, there is provided a transmitting unit being capable of transmitting radio signals in an orthogonal frequency division multiplexing method including;

an acquiring unit to acquire information about channel quality detected in a receiving unit;

a spreading rate selecting unit to select 1 (one) as a spreading rate when the channel quality exceeds a predetermined level and to select a spreading rate being preset so that, as the channel quality becomes degraded, a larger value is selected according to the channel quality when the channel quality is less than the predetermined level; and

a spreading unit to perform code spreading on transmitting signals by using the spreading rate selected by the spreading rate selecting unit.

In the foregoing third aspect, a preferable mode is one wherein the spreading unit performs code spreading on an axis of a frequency by using the spreading rate selected by the spreading rate selecting unit.

Also, a preferable mode is one wherein the spreading unit performs code spreading on an axis of time by using the spreading rate selected by the spreading rate selecting unit.

Also, a preferable mode is one wherein the spreading rate selecting unit, when performing code multiplexing by using two or more types of codes, selects a multiplied spreading rate obtained by multiplying a spreading rate, to be selected when the code multiplexing is not performed, by a number of the types of the codes to be multiplexed.

According to a fourth aspect of the present invention, there is provided a receiving unit being capable of demodulating radio signals transmitted according to an orthogonal frequency division multiplexing method including:

a channel quality estimating unit to detect channel quality from a received signal;

an acquiring unit to obtain a spreading rate selected by a transmitting unit based on the channel quality; and

a despreading unit to perform despreading by using a spreading rate obtained from the transmitting unit.

In the foregoing fourth aspect, a preferable mode is one wherein the channel quality estimating unit outputs a signal-to-noise ratio as the channel quality.

Also, a preferable mode is one wherein the channel quality estimating unit outputs a signal-to-interference ratio as the channel quality.

Also, a preferable mode is one wherein the channel quality estimating unit outputs information about a ratio of a signal power to a sum of noise power and interference power as the channel quality.

Also, a preferable mode is one wherein the despreading unit performs despreading on an axis of a frequency by using the spreading rate obtained from the transmitting unit.

Also, a preferable mode is one wherein the despreading unit performs despreading on an axis of time by using the spreading rate obtained from the transmitting unit.

Also, a preferable mode is one wherein the despreading unit, when the transmitting unit performs code multiplexing by using two or more types of codes, acquires a number of multiplexing through the acquiring unit and performs the despreading using the obtained number of multiplexing

With the above configurations, by transmitting and receiving, when channel quality exceeds a predetermined level, radio signals according to an OFDM method and by performing, when a channel quality is less than a predetermined level, code spreading and despreading using a spreading rate being predetermined so that, as the channel quality becomes degraded, a larger value is selected to transmit and receive information, communications are made possible, since a gain in spreading can be obtained due to code spreading, communications even in an area where communications using the OFDM method are impossible can be made possible. Therefore, communicable areas can be expanded and occurrence of areas where communications using a multicell-configured radio communication system are not enabled can be avoided.

Moreover, since code spreading is not performed in a place where the channel quality exceeds a predetermined level, unlike in a case of using a conventional multi-carrier CDMA method and a multi-carrier DS-CDMA method in which data rate is lowered, an average throughput that can be achieved by a base station and by a radio communication system made up of the base station and terminal device can be improved.

### BRIEF DESCRIPTION OF THE DRAWINGS

The above and other objects, advantages, and features of the present invention will be more apparent from the following description taken in conjunction with the accompanying drawings in which:

FIG. 1A is a schematic block diagram showing a radio transmitting unit (device) making up a radio communication system (a radio transmitting and receiving device) according to a first embodiment of the present invention, and FIG. 1B is a schematic block diagram showing a radio receiving unit (device), making up the same radio communication system (the same radio transmitting and receiving device);

FIG. 2 is a schematic diagram illustrating an example of a configuration of a cell to which a method for selecting a spreading rate in a spreading rate selecting section is applied according to the first embodiment of the present invention;

FIG. 3 is a schematic diagram illustrating an example of another configuration of a cell to which the method for selecting the spreading rate in the spreading rate selecting section is applied according to the first embodiment of the present invention;

FIG. 4 is a schematic diagram illustrating an example of still another configuration of a cell to which the method for selecting the spreading rate in the spreading rate selecting section is applied according to the first embodiment of the present invention;

FIG. 5A is a schematic block diagram showing a radio transmitting unit (device) making up a radio communication system (a radio transmitting and receiving device) according to a second embodiment of the present invention, and FIG. 5B is a schematic block diagram showing a radio receiving unit (device), making up the same radio communication system (the same radio transmitting and receiving device);

FIG. 6 is a diagram showing a method for selecting an optimum spreading rate in a spreading rate selecting section in a transmitting unit of the second embodiment of the present invention;

FIGS. 7A and 7B are schematic block diagrams showing, as a whole, configurations of a conventional radio transmitting and receiving devices by using an OFDM method;

FIGS. 8A and 8B are schematic block diagrams showing, as a whole, configurations of a conventional radio transmitting and receiving devices by using a multi-carrier CDMA method; and

FIGS. 9A and 9B are schematic block diagrams showing, as a whole, configurations of a conventional radio transmitting and receiving devices by using a multi-carrier DS-CDMA method.

### DETAILED DESCRIPTION OF THE PREFERRED EMBODIMENTS

Best modes of carrying out the present invention will be described in further detail using various embodiments with reference to the accompanying drawings.

First Embodiment

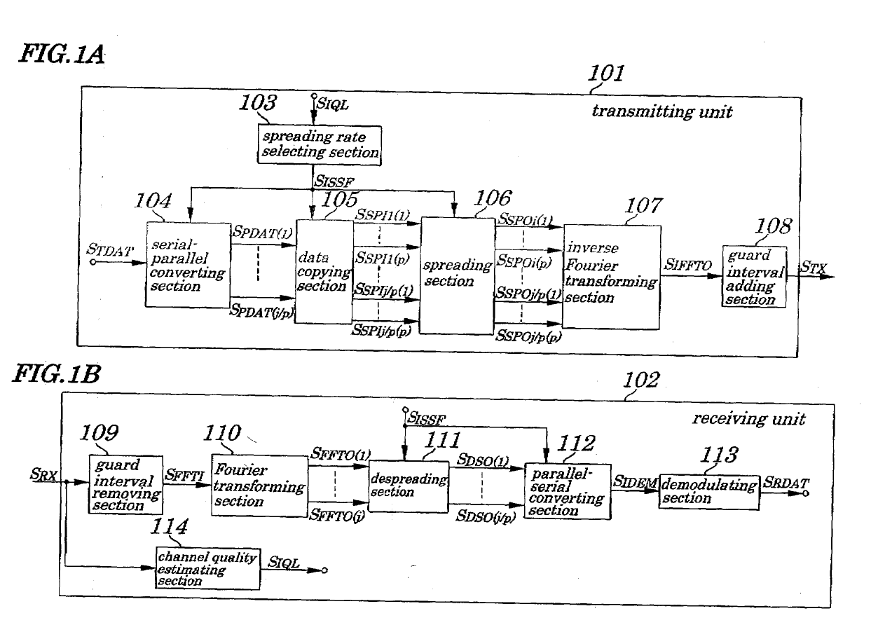

FIGS. 1A and 1B are schematic block diagrams showing, as a whole, configurations of a radio communication system having a radio transmitting and receiving device according to a first embodiment of the present invention. In the embodiment, the radio transmitting and receiving device is provided with a radio transmitting unit (device) 101 as shown in FIG. 1A, and a radio receiving unit (device) 102 as shown in FIG. 1B.

As shown in FIG. 1A, the transmitting unit 101 includes a spreading rate selecting section 103, a serial-parallel converting section 104, a data copying section 105, a spreading section 106, an inverse Fourier transforming section 107, and a guard interval adding section 108. As shown in FIG. 1B, the receiving unit 102 includes a guard interval removing section 109, a Fourier transforming section 110, a despreading section 111, a parallel-serial converting section 112, a demodulating section 113, and a channel quality estimating section 114.

The spreading rate selecting section 103 in the transmitting unit 101 selects, based on a channel quality information signal S_{IQL} obtained from the receiving unit 102, an optimum spreading rate and outputs a selected spreading rate information signal S_{ISSF} showing a selected spreading rate.

The serial-parallel converting section 104 receives the selected spreading rate information signal S_{ISSF} output from the spreading rate selecting section 103 and transmitting data S_{TDAT} and converts the transmitting data S_{TDAT} being serial data into j/p (“j” is an integer being not less than 2, “p” is 1 or an integer being not less than 2 which becomes sub-multiples of “j” and is equivalent to a spreading rate shown by the selected spreading rate information signal S_{ISSF}) pieces of parallel data signals S_{PDAT} (1) to S_{PDAT} (j/p).

The data copying section 105 receives the selected spreading rate information signal S_{ISSF} output from the spreading rate selecting section 103 and the parallel data signals S_{PDAT} (1) to S_{PDAT} (j/p) output from the serial-parallel converting section 104 and copies p-pieces of each of the parallel data signals S_{PDAT} (1) to S_{PDAT} (j/p) and outputs them as spread section input signals S_{SPI1} (1) to S_{SPI1} (p) , S_{SPI2} (1) to S_{SPI2} (p) , . . . , S_{SPIj/p} (1) to S_{SPIj/p} (p).

The spreading section 106 receives the selected spreading rate information signal S_{ISSF} output from the spreading rate selecting section 103 and spreading section input signals S_{SPI1} (1) to S_{SPI1} (P), S_{SPI2} (1 ) to S_{SPI2} (p), . . . , S_{SPIj/p} (1) to S_{SPIj/p} (p) output from the data copying section 105 and performs code spreading on each of the spreading section input signals S_{SPI1} (1) to S_{SPI1} (p), S_{SPI2} (1) to S_{SPI2} (p), . . . , S_{SPIj/p} (1) to S_{SPIj/p} (p) using spreading codes having a code length “p” on an axis of a frequency employed in an OFDM (Orthogonal Frequency Division Multiplexing) method and outputs spreading section output signals S_{SPO1} (1) to S_{SPO1} (P), S_{SPO2} (1) to S_{SPO2} (p), . . . , S_{SPOj/p} (1) to S_{SPOj/p} (P).

The inverse Fourier transforming section 107 performs inverse Fourier transformation on each of the spreading section output signals S_{SPO1} (1) to S_{SPO1} (p), S_{SPO2} (1) to S_{SPO2} (p), . . . , S_{SPOj/p} (1) to S_{SPOj/p} (p) and outputs an inverse Fourier transformed output signal S_{IFFTO}.

The guard interval adding section 108 copies part of the inverse Fourier transformed output signal S_{IFFTO} output from the inverse Fourier transforming section 107 and adds the copied signal as a guard interval to the inverse Fourier transformed output signal S_{IFFTO} and outputs the resultant signal as a transmitting signal S_{TX}.

On the other hand, the guard interval removing section 109 in the receiving unit 102 removes the guard interval from a received signal S_{RX} (called as a transmitting signal S_{TX} in the transmitting unit 101) and outputs the resulting signal as a Fourier transforming input signal S_{FFTI}.

The Fourier transforming section 110 performs Fourier transformation on the Fourier transforming input signal S_{FFTI} output from the guard interval removing section 109 and outputs j-pieces (“j” is an integer being not less than 2) of Fourier transformed output signals S_{FFTO} (1) to S_{FFTO} (j).

The despreading section 111 receives the selected spreading rate information signal S_{ISSF} output from the transmitting unit 101 and the Fourier transformed output signals S_{FFTO} (1) to S_{FFTO} (j) output from the Fourier transforming section 110 and performs despreading on the Fourier transformed output signals S_{FFTO} (1) to S_{FFTO} (j) on an axis of a frequency employed in the OFDM method and outputs j/p (“j” is an integer being not less than 2, “p” is 1 or an integer being not less than 2 which becomes sub-multiples of “j” and is equivalent to a spreading rate shown by the selected spreading rate information signal S_{ISSF}) pieces of despreading output signals S_{DSO} (1) to S_{DSO} (j/p)

The parallel-serial converting section 112 receives the selected spreading rate information signal S_{ISSF} output from the transmitting unit 101 and the despreading output signals S_{DSO} (1) to S_{DSO} (j/p) output from the despreading section 111 and converts the despreading output signals S_{DSO} (1) to S_{DSO} (j/p) into serial data and outputs a demodulating section input signal S_{IDEM}.

The demodulating section 113 demodulates the demodulating section input signal S_{IDEM} fed from the parallel-serial converting section 112 and outputs the demodulated signals as a received data signal S_{RDAT}.

The channel quality estimating section 114 estimates channel quality using the received signal S_{RX} and outputs a channel quality information signal S_{IQL} showing a result from the estimation.

The radio transmitting and receiving device of the first embodiment is so constructed that, in a place where its channel quality exceeds a predetermined level, it transmits and receives radio signals according to the OFDM method and, in a place where its channel quality is less than a predetermined level, it selects an optimum spreading rate according to the channel quality and transmits and receives radio signals in the same method as a multi-carrier CDMA (Code Division Multiple Access) method. Moreover, the spreading section 106 in the transmitting unit 101 may perform code spreading on an axis of time employed in the OFDM method and the despreading section 111 in the receiving unit 102 may perform despreading on an axis of time employed in the OFDM method. In this case, configurations of the radio transmitting and receiving device of the first embodiment become same as those in the case where it transmits and receives radio signals in the same method as a multi-carrier DS-CDMA (Direct Sequence-Code Division Multiple Access) method in a place where channel quality does not satisfy a predetermined value.

The channel quality information signal S_{IQL} can be obtained in the transmitting unit 101 by causing the receiving unit 102 to have a notifying component used to notify information estimated by the channel quality estimating section 114 and the transmitting unit 101 to have an information acquiring component used to receive the information on results from the estimation. Moreover, selected the spreading rate information signal S_{ISSF} can be obtained in the receiving unit 102, for example, by causing the transmitting unit 101 to have a notifying component used to multiplex the transmitting signal S_{TX} and selected spreading rate information signal S_{ISSF} and to transmit the resulting signals and by causing the receiving unit 102 to have an obtaining component used to separate the selected spreading rate information signal S_{ISSP} from the received signal S_{RX}.

Furthermore, it is not necessary for the transmitting unit 101 to acquire the channel quality information signal S_{IQL} from the receiving unit 102 adapted to receive a transmitting signal of the transmitting unit 101 itself. For example, when information is transmitted or received between radio transmitting and receiving devices each having the transmitting unit 101 as shown in FIG. 1A and the receiving unit 102 as shown in FIG. 1B and when channel quality in upward communication is equal to that of downward communication, it is possible for the transmitting unit 101 to acquire the channel quality information signal S_{IQL} from the receiving unit 102 existing within a same station, a same radio transmitting and receiving device. In this case, the receiving unit 102 can acquire the selected spreading rate information signal S_{ISSF} from the transmitting unit 101 existing within the same station.

Next, a method for selecting an optimum spreading rate in the spreading rate selecting section 103 in the transmitting unit 101 shown in FIG. 1A will be specifically described below.

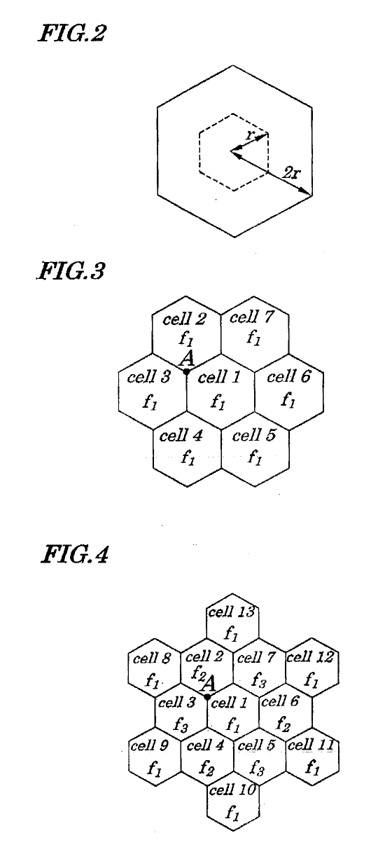

First, a base station (not shown) being placed in a vicinity of a center of a cell shown in FIG. 2 is provided with the transmitting unit 101 shown in FIG. 1A and a terminal device to receive information from the base station is provided with the receiving unit 102 shown in FIG. 1B.

For example, now let it be assumed that an SNR (signal-to-noise ratio) required as channel quality enabling communications using the OFDM method is not less than 10 dB. The SNR occurring at a place being 2r (“r” is a radius of a cell in which communication using the OFDM method is possible) apart from a base station when propagation loss in a radio signal is proportional to the fourth power of a distance is given by a following expression;

SNR=10−10 log₁₀ (2r/r)⁴≈2 dB Expression (1)

In this case, the above SNR does not satisfy channel quality enabling communications using the OFDM method. Moreover, the SNR is calculated in the channel quality estimating section 114 based on the received signal S_{RX} and is output as the channel quality information signal S_{IQL}.

When a minimum value out of powers of 2 that can satisfy a following expression is selected in the spreading rate selecting section 103, if the SNR=−2 dB, p=16:

p≧10^{(10-SNR)/10} Expression (2)

where “p” denotes a spreading rate.

Therefore, since, by setting the spreading rate to be used in the transmitting unit 101 and the receiving unit 102 to be 16 and by lowering a data rate to 1/16, a gain in spreading being about 12 dB is obtained, communications between the base station and the terminal device being placed by “2 r” apart from the base station are made possible.

Moreover, radio communications using the OFDM method with the terminal device being placed within “r” from the base station and having a sufficiently large SNR can be carried out by selecting the spreading rate “p” being 1 (one) in the spreading rate selecting section 103.

Thus, according to the first embodiment of the present invention, a communicable area can be expanded by carrying out radio communications using the OFDM with degradation of its channel quality being reduced in a place where the SNR is large, that is, channel quality is excellent, even in multipath environments and by using the code spreading method in a place where the SNR is small, that is, channel quality is poor, and by selecting an optimum spreading rate according to the value of the SNR and by lowering a data rate to 1/spreading rate to obtain a gain in spreading. Moreover, in the radio transmitting and receiving device using the conventional multi-carrier CDMA method or using the conventional multi-carrier DS-CDMA method, even in a range where communications using the OFDM method can be carried out, data rate is lowered according to a spreading rate. However, according to the present invention, since, even in the place where the SNR is large, there is no need for lowering the data rate, an average throughput that can be achieved by the base station and by the radio communication system made up of the base station and the terminal device can be improved.

Next, a method for selecting an optimum spreading rate in the spreading rate selecting section 103 in the transmitting unit 101 shown in FIG. 1A in multi-cell environments will be described. In the description below, let it be assumed that the base station being placed in a vicinity of a center of each cell is provided with the transmitting unit 101 shown in FIG. 1A and the terminal device adapted to perform transmitting and receiving of information with the base station is provided with the receiving unit 102 shown in FIG. 1E.

First, a method for selecting a spreading rate in the multi-cell environments as shown in FIG. 3 will be explained.

All of cells as shown in FIG. 3 are so configured that communications are carried out by using same frequency f₁ (one cell reuse). Moreover, in the configurations shown in FIG. 3, a radio signal is transmitted from the base station being placed at a center of a cell 1 to the terminal device being placed at a boundary point “A” among three cells (cell 1, cell 2, and cell 3) and all base stations existing in cells 1 to 7 transmit signals at a same time and by using a same transmission power. Therefore, the base station existing in each of the cells 2 to 7 acts as a source of interference against the terminal device being placed at the boundary point A.

For example, let it be assumed that the SIR (signal-to-interference ratio) as channel quality enabling communications using the OFDM method is not less than 10 dB. Here, if a distance from the base station existing in each of the cells 2 to 7 to the boundary point A is sequentially by 1 time, 1 time, 2 times, 7^{1/2} times, 7^{1/2} times, 2 times larger than a distance from the base station existing in he cell 1 to the boundary point A and propagation loss in a radio signal is proportional to the fourth power of a distance, the SIR at the boundary point A is given by a following expression:

$$SNR = 10 - 10 {log}_{10} \{ \frac{1}{{1}^{4} + {1}^{4} + {( 1 / 2 )}^{4} + \sqrt{1 / 7} {}^{4} + \sqrt{1 / 7} {}^{4} + {( 1 / 2 )}^{4}} \} ≅ - 3.4 dB \qquad Expression ( 3 )$$

In this case, the SIR does not satisfy channel quality that enables communications using the OFDM method. The SIR is calculated based on the received signal S_{RX} in the channel quality estimating section 114 and is output as the channel quality information signal S_{IQL}.

When a minimum value out of powers of 2 that can satisfy a following expression is selected in the spreading rate selecting section 103, if the SIR=−3.4 dB, p=32:

p≧10^{(10-SIR)/10} Expression (4)

where “p” denotes a spreading rate.

Therefore, since, by setting the spreading rate to be used in the transmitting unit 101 and the receiving unit 102 to be at 32 and by lowering the data rate to 1/32, a gain in spreading being about 15 dB is obtained, communications between the base station in the cell 1 shown in FIG. 3 and the boundary point A are made possible.

Moreover, radio communications using the OFDM method with the terminal device having a sufficiently large SIR can be carried out by selecting the spreading rate “p” being 1 (one) in the spreading rate selecting section 103.

Thus, according to the first embodiment of the present invention, in a place where the SIR is large, that is, channel quality is excellent, even in multipath environments, radio communications using the OFDM with degradation of its channel quality being reduced can be carried out. In a place where the SIR is small, that is, channel quality is poor, by applying a code spreading method and by selecting an optimum spreading rate according to the value of the SIR and by lowering a data rate to 1/spreading rate to obtain a gain in code spreading, even in the multi-cell configuration by one cell reuse, occurrence of a non-communicable area can be avoided and a high average throughput that can be obtained by the base station and by the radio communication system can be achieved.

Next, a method for selecting a spreading rate in multi-cell environments will be described by referring to FIG. 4.

Each of cells shown in FIG. 4 is so configured that communications are carried out by using three types of frequencies f₁, f₂₁ and f₃ (three cell reuse). Moreover, in the configurations shown in FIG. 4, a radio signal is transmitted from the base station existing in a center of a cell 1 to a terminal device being placed at a boundary point A among three cells (cell 1, cell 2, and cell 3) and base stations existing in cells 1 to 13 transmit signals at a same time and by same transmission power. Therefore, the base station existing in each of the cells 8 to 13 acts as a source of interference in a same channel against the terminal device being placed at the boundary point A. Moreover, the present invention is not limited to the configuration in which a cell carries out communications using such the three types of frequencies f₁, f₂, and f₃ and the cell may be also constructed so that the communications are carried out by using two or more types of frequencies.

For example, let it be assumed that a signal-to-interference ratio (SIR) as channel quality enabling communications using the OFDM method is not less than 10 dB. Here, if a distance from the base station existing in each of the cells 8 to 13 to the boundary point A is sequentially by 2 times, 7^{1/2} times, 13^{1/2} times, 4 times, 13^{1/2} times, 7^{1/2} times larger than a distance from the base station existing in the cell 1 to the boundary point A and propagation loss in a radio signal is proportional to the 3.5 th power of a distance, the SIR at the boundary point A is given by a following expression:

$$SIR = 10 - 10 {log}_{10} \{ \frac{1}{{2}^{3.5} + \sqrt{1 / 7} {}^{3.5} + \sqrt{1 / 13} {}^{3.5} + {( 1 / 4 )}^{3.5} + \sqrt{1 / 13} {}^{3.5} + \sqrt{1 / 7} {}^{3.5}} \} ≅ 7.3 dB \qquad Expression ( 5 )$$

In this case, the SIR does not satisfy channel quality that enables communications using the OFDM method. The SIR is calculated based on the received signal S_{RX} in the channel quality estimating section 114 and is output as the channel quality information signal S_{IQL}.

When a minimum value out of powers of 2 that can satisfy a following expression is selected in the spreading rate selecting section 103, if the SIR=7.3 dB, p=2:

p≧10^{(10-SIR)/10} Expression (6)

where “p” denotes a spreading rate

Therefore, since, by setting the spreading rate to be used in the transmitting unit 101 and the receiving unit 102 to be at 2 and by lowering the data rate to ½, a gain in spreading being about 3 dB is obtained, communications between the base station in the cell 1 shown in FIG. 4 and the boundary point A are made possible.

Moreover, radio communications using the OPOM method with the terminal device having a sufficiently large SIR can be carried out by selecting the spreading rate “p” being 1 (one) in the spreading rate selecting section 103.

Thus, according to the first embodiment of the present invention, by carrying out radio communications using the OFDM with degradation of its channel quality being reduced in a place where the SIR is large, that is, channel quality is excellent, even in multipath environments, and in a place where the SIR is small, that is, channel quality is poor, by applying a code spreading method and by selecting an optimum spreading rate according to the value of the SIR and by lowering a data rate to 1/spreading rate to obtain a gain in code spreading, even in the multi-cell configuration by three cell reuse, occurrence of the non-communicable area can be avoided and a high average throughput that can be obtained by the base station and by the radio communication system can be achieved.

Second Embodiment

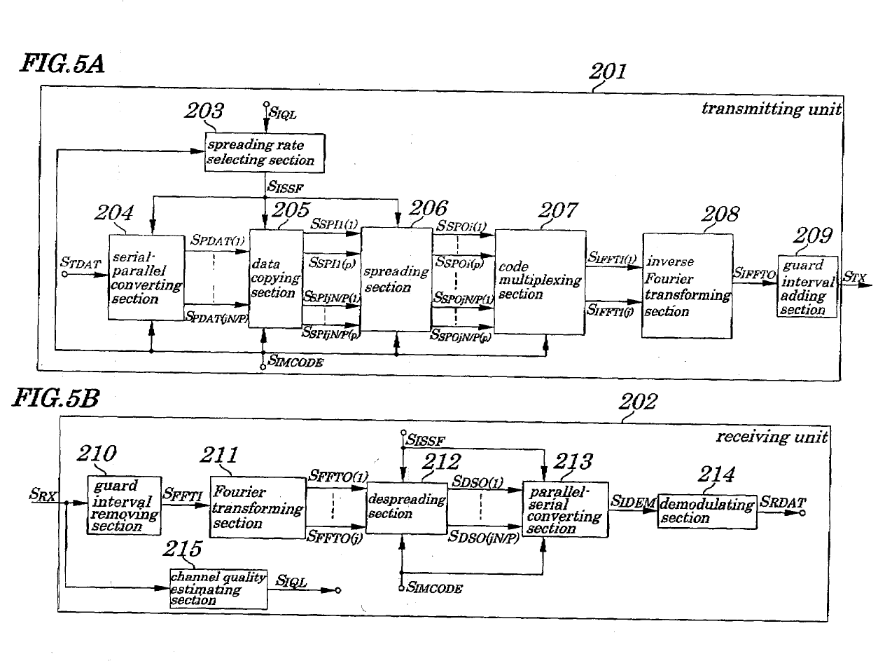

FIGS. 5A and 5B are schematic block diagrams showing, as a whole, configurations of a radio communication system having a radio transmitting and receiving device according to a second embodiment of the present invention. In the embodiment, the radio transmitting and receiving device is provided with a radio transmitting unit (device) 201 as shown in FIG. 5A, and a radio receiving unit (device) 202 as shown in FIG. 5B.

As shown in FIG. 5A, the transmitting unit 201 includes a spread rate selecting section 203, a serial-parallel converting section 204, a data copying section 205, a spreading section 206, a code multiplexing section 207, an inverse Fourier transforming section 208, and a guard interval adding section 209, Also, as shown in FIG. 5E, the receiving unit 202 includes a guard interval removing section 210, a Fourier transforming section 211, a despreading section 212, a parallel-serial converting section 213, a demodulating section 214, and a line guard estimating section 215.

The spreading rate selecting section 203 in the transmitting unit 201 selects an optimum spreading rate based on a channel quality information signal S_{IQL} being obtained from the receiving unit 202 described later and a code multiplexing number information signal S_{IMCODE} being determined depending on a number of communicating parties to or from which information is transmitted or received by a control unit (not shown) provided in a base station (not shown) or in a terminal device (not shown) and then outputs a selected spreading rate information signal S_{ISSF} indicating selected spreading rate. Moreover, the above control unit is made up of, for example, a CPU (not shown), a storage device (not shown) to temporarily store information required for processing in the CPU, and a storage medium (not shown) in which a program to have the CPU execute control processing is stored.

The serial-parallel converting section 204 receives the selected spreading rate information signal S_{ISSF} output from the spread rate selecting section 203, the code multiplexing number information signal S_{IMCODE}, and a transmitting data S_{TDAT} and converts the transmitting data S_{TDAT} being serial data into jN/p (“j” is an integer being rot less than 2, “N” is an integer being not less than 2, “p” is 1 or an integer being not less than 2 which becomes sub multiples of “j”, “N” is equivalent to a code multiplexing number shown as the code multiplexing number information signal S_{IMCODE}, and “p” is equivalent to a spreading rate shown as the selected spreading rate information signal S_{ISSF}) pieces of parallel data signals S_{PDAT} (1) to S_{PDAT} (jN/p).

The data copying section 205 receives the selected spreading rate information signal S_{ISSF} output from the spreading rate selecting section 203, the code multiplexing number information signal S_{IMCODE}, and parallel data signals S_{PDAT} (1) to S_{PDAT} (jN/p) and copies p-pieces of each of the parallel data signals S_{PDAT} (1) to S_{PDAT} (jN/p) output from the serial-parallel converting section 204, and outputs spreading section input signals S_{SPI1} (1) to S_{SPI1} (P), S_{SPI2} (1) to S_{SPI2} (P), . . . , and S_{SPIjN/p} (1) to S_{SFIjN/P} (p).

The spreading section 206 receives the selected spreading rate information signal S_{ISSF} output from the spreading rate selecting section 203, the code multiplexing number information signal S_{IMCODE}, and the spreading section input signals S_{SPI1} (1) to S_{SPI1} (P), S_{SPI2} (1) to S_{SPI2} (p) , . . . , and S_{SPIjN/p} (1) to S_{SPIjN/p} (p) output from the data copying section 205 and performs code spreading on spreading input S_{SPI(1+ij/p)} (1) to S_{S}_{SPI(1+ij/p)} (p), S_{SPI(2+ij/p)} to S_{SPI(2+j/p)} (p), and S_{SPI(j/p+ij/p)} (1) to S_{SPI(j/p+ij/p)} (p) (i=0, 1, . . . , N−1) by using i-th (i=0, 1, . . . , N−1) spreading codes each having a code length “p” on an axis of a frequency employed in a OFDM method and outputs spreading section output signals S_{SPO1} (1) to S_{SPO1} (P), S_{SPO2} (1) to S_{SPO2} (p), . . . , and S_{SPOjN/p} (1) to S_{SPOjN/p} (p),

The code multiplexing section 207 receives the code multiplexing number information signal S_{IMCODE}, and the spreading section output signals S_{SPO1} (1) to S_{SPO1} (p), S_{SPO2} (1) to S_{SPO2} (P), . . . , and S_{SPOjN/p} (1) to S_{SPOjN/p} (p) output from the spreading section 206 and performs multi-code multiplexing on the spreading section output signals S_{SPO1} (1) to S_{SPO1} (p), S_{SPO2} (1) to S_{SPO2} (p) , . . . , and S_{SPOjN/p} (1) to S_{SPOjN/p} (p) by using N-pieces of spreading codes intersecting at right angles and outputs inverse Fourier transforming input signals S_{IFFTI} (1) to S_{IFFTI} (j).

The inverse Fourier transforming section 208 performs inverse Fourier transformation on the inverse Fourier transforming input signals S_{IFFTI} (1) to S_{IFFTI} (j) output from the code multiplexing section 207 and outputs an inverse Fourier transformed output signal S_{IFFTO}.

The guard interval adding section 209 copies a part of the inverse Fourier transformed output signal S_{IFFTO} output from the inverse Fourier transforming section 208 and adds the copied part to the inverse Fourier transformed output signal S_{IFFTO} as a guard interval and outputs the signal as a transmitting signal S_{TX}.

On the other hand, the guard interval removing section 210 in the receiving unit 202 removes the guard interval from a received signal S_{RX} and outputs the signal as a Fourier transforming input signal S_{FFTI}.

The Fourier transforming section 211 performs Fourier transformation on the Fourier transforming input signal S_{FFTI} output from the guard interval removing section 210 and outputs Fourier transformed output signals S_{FFTO} (1) to S_{FFTO} (j).

The despreading section 212 receives the selected spreading rate information signal S_{ISSF} output from the transmitting unit 201, the code multiplexing number information signal S_{IMCODE}, and the Fourier transformed output signals S_{FFTO} (1) to S_{FFTO} (j) output from the Fourier transforming section 211 and performs despreading on the Fourier transformed output signals S_{FFTO} (1) to S_{FFTO} (j) by using N-pieces of spreading codes having a code length “p” and intersecting at right angles on an axis of a frequency employed it in the OFDM method and outputs jN/p (“j” is an integer being not less than 2, “N” is an integer being not less than 2, “p” is 1 or an integer being not less than 2 which becomes submultiples of “j”, “N” is equivalent to a code multiplexing number shown as the code multiplexing number information signal S_{IMCODE}, and “p” is equivalent to a spreading rate shown as the selected spreading rate information signal S_{ISSF}) pieces of despreading output signals S_{DSO} (1) to S_{DSO} (jN/p).

The parallel-serial converting section 213 receives the selected spreading rate information signal S_{ISSF} output from the transmitting unit 201, the code multiplexing number information signal S_{IMCODE}, and the despreading output signals S_{DSO} (1) to S_{DSO} (jN/p) and converts the despreading output signals S_{DSO} (1) to S_{DSO} (jN/p) into serial data and outputs a demodulating section input signal S_{IDEM}.

The demodulating section 214 demodulates signals transmitted based on the demodulating section input signal S_{IDEM} output from the parallel-serial converting section 213 and outputs the demodulated signals as a receiving data signal S_{RDAT}.

The channel quality estimating section 215 estimates channel quality from the received signal S_{RX} and outputs the channel quality information signal S_{IQL}.

The radio transmitting and receiving device of the second embodiment is so configured that, in a place where channel quality exceeds a predetermined level, if code multiplexing is not performed radio signals are transmitted or received according to the OFDM method and, if the code multiplexing is performed, radio signals are transmitted or received, by selecting a spreading rate corresponding to a number of multiplexing, in the same method as in a multi-carrier CDMA method. On the other hand, the above radio transmitting and receiving device is configured so that, in a place where channel quality is less than a predetermined level, radio signals are Transmitted or received, by selecting an optimum spreading rate co-responding to the channel quality and a number of code multiplexing, in the same method as in the multi-carrier CDMA method. Moreover, the spreading section 206 of the transmitting unit 201 may perform code spreading on spreading section input signals by using i-th (“i” is 0, 1, . . . , N−1) spreading signals having a code length “p” on an axis of time employed in the OFDM method. Also, the despreading section 212 in the receiving unit 202 may perform despreading on Fourier transformed output signals by using N-pieces of spreading codes having a code length “p” and intersecting at right angles on an axis of time employed in the OFDM method. In this case, the radio transmitting and receiving device of the second embodiment is so configured that, when code multiplexing is performed or when channel quality does not reach a predetermined level, radio signals are transmitted or received in the same method as in a multi-carrier DS-CDMA method.

Acquisition of the channel quality information signal S_{IQL} in the transmitting unit 201 can be achieved by having the receiving unit 202 be provided with a notifying unit that can notify (not shown) the receiving unit 202 of information obtained by estimation in the channel quality estimating section 215 and by having the transmitting unit 201 be provided with an acquiring unit (not shown) that can receive the information. Also, acquisition of the selected spreading rate information signal S_{ISSF} in the receiving unit 202 can be achieved by having the transmitting unit 201 be provided with a notifying unit (not shown) that can multiplex the transmitting signal S_{TX} and selected spreading rate information signal S_{ISSF} and transmit them to the transmitting unit 201 and by having the receiving unit 202 be provided with an acquiring unit that can separate and acquire the selected spreading rate information signal S_{ISSF} from the received signal S_{RX}.

Moreover, acquisition of the code multiplexing number information signal S_{IMCODE} in the receiving unit 202 can be achieved by multiplexing the code multiplexing number information signal S_{IMCODE} and the transmitting signal S_{TX} and by transmitting the multiplexed signal using the notifying unit in the above transmitting unit 201 and by separating the code multiplexing number information signal S_{IMCODE} from the received signal S_{RX} using the above acquiring unit in the receiving unit 202.

Furthermore, it is not necessary for the transmitting unit 201 to acquire the channel quality information signal S_{IQL} from the receiving unit 202 adapted to receive a transmitting signal from the transmitting unit 201 within the radio transmitting and receiving device For example, as in the case of the first embodiment, when information is transmitted or received between two radio transmitting and receiving devices each having the transmitting unit 201 as shown in FIG. 5A and the receiving unit 202 as shown in FIG. 5B and when channel quality in upward communication is equal to that of downward communication, it is possible for the transmitting unit 201 to acquire the channel quality information signal S_{IQL} from the receiving unit 202 existing within a self-station. In this case, the receiving unit 202 can acquire the selected spreading rate information signal S_{ISSF} and the code multiplexing number information signal S_{IMCODE} from the transmitting unit 201 existing within the self-station.

Next, a method for selecting an optimum spreading rate in the spreading rate selecting section 203 in the transmitting unit 201 in FIG. 5A will be described.

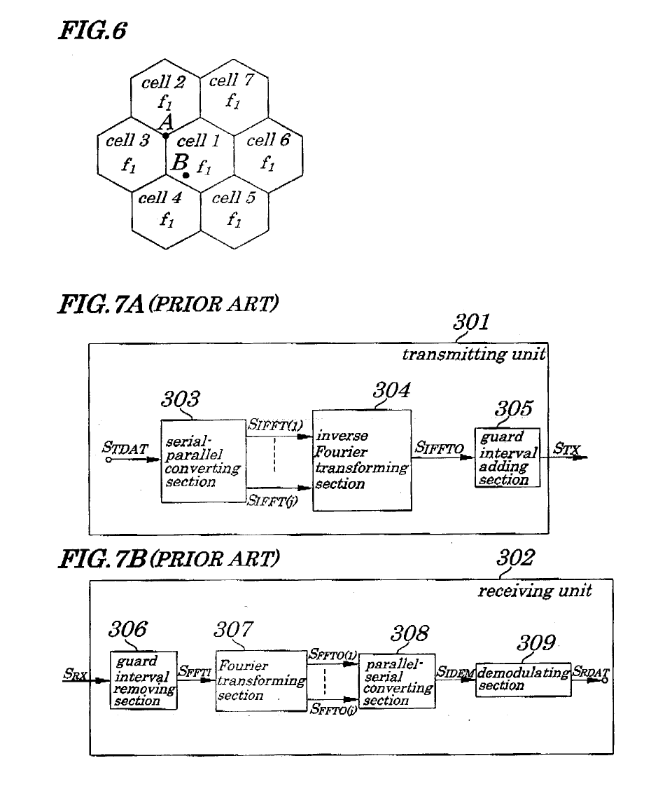

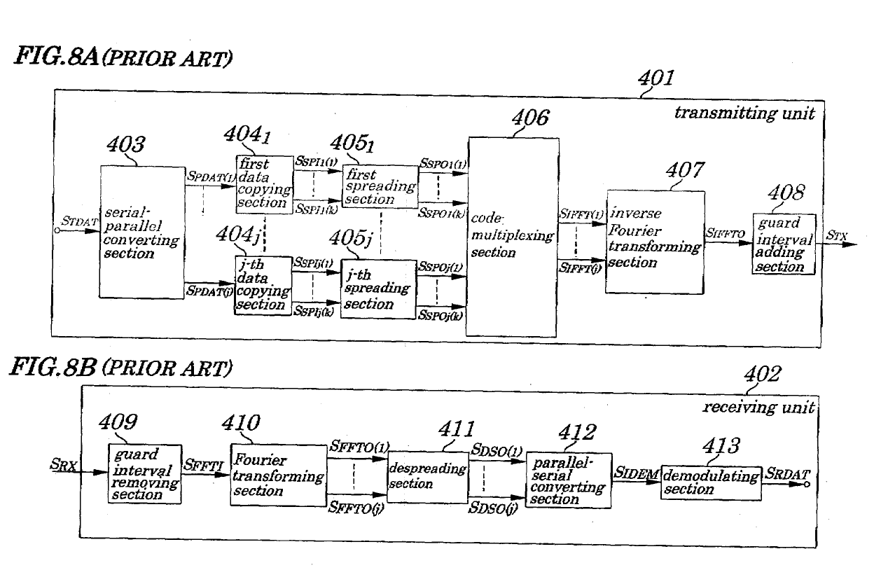

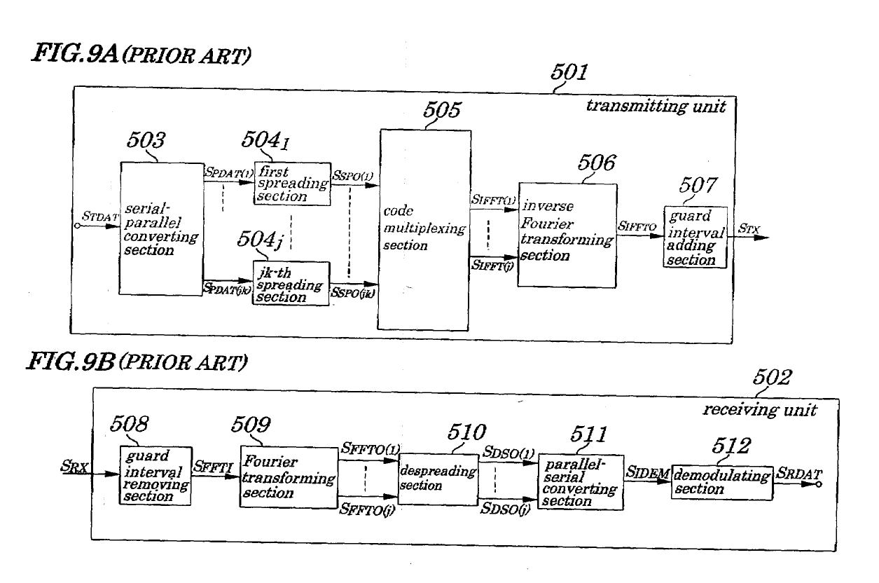

Here, let it be assumed that, in multi cell environments shown in FIG. 6, a base station existing in a vicinity of a center of each of cells has the transmitting unit 201 shown in FIG. 5A and a terminal device performing transmitting and receiving of information to and from the base station has the receiving unit 202 shown in FIG. 5B.

Also, let it be assumed that each of the cells shown in FIG. 6 is so configured that communications are carried out by using a same frequency f₁ therein (one cell reuse) and radio signal is transmitted from a base station existing in a center of one cell 1 to a terminal device being placed at a boundary point A of three cells (cell 1, cell 2, and cell 3) and another terminal device being placed at a B point within the cell 1 and base stations being placed in cells 1 to 7 by same transmission power and at a same time. Therefore, all the base stations existing in cells 2 to 7 act as a source of interference against the terminal device being placed at a boundary point A.

For example, let it be assumed that a signal-to-interference ratio (SIR) as channel quality enabling communications using the OFDM method is not less than 10 dB. Here, if a distance from the base station existing in each of the cells 2 to 7 to the boundary point A is sequentially by 1 time, 1 time, 2 times, 7^{1/2} times, 7^{1/2} times, 2 times larger than a distance from the base station existing in the cell 1 to the boundary point A and propagation loss in a radio signal is proportional to the fourth power of a distance, the SIR at the boundary point A is given by a following expression:

$$SIR = 10 - 10 {log}_{10} \{ \frac{1}{{1}^{4} + {1}^{4} + {( 1 / 2 )}^{4} + \sqrt{1 / 7} {}^{4} + \sqrt{1 / 7} {}^{4} + {( 1 / 2 )}^{4}} \} ≅ - 3.4 dB \qquad Expression ( 7 )$$

In this case, the SIR does not satisfy channel quality that enables communications using the OFDM method. The SIR is calculated based on the received signal S_{RX} in the channel quality estimating section 215 and is output as the channel quality information Signal S_{IQL}.

When a minimum value out of powers of 2 that can satisfy a following expression is selected in the spreading rate selecting section 203, if the SIR=−3.4dB, p=32:

p≧10^{(10-SIR)/10} Expression (8)

where “p” denotes a spreading rate.

Therefore, in the case where communications are carried out between the base station in the cell 1 and the terminal device being placed at the boundary point A in the cell 1, by setting the spreading rate “p” to be 32 and by lowering the data rate to 1/32, a gain in spreading being about 15 dB is obtained. However, when communications with the terminal device being placed at a point B have to be carried out at a same time, power to be assigned to one code is reduced to a half by performing code multiplexing.

At this point, the SIR per one code at the point A becomes −6.4 dB, even it a spreading gain 15 dB is used, required quality cannot be satisfied. To solve this problem, a minimum value out of powers of 2 that can satisfy a following expression is selected in the spreading rate selecting section 203.

p≧10^{(10-SIR)/10}×N Expression (9)

where “p” denotes a spreading rate and “N” denotes a number of code multiplexing.

That is, when SIR=−3.4 dB and the number of code multiplexing N=2, p=64. Here, either an SIR obtained at the point A or the SIR obtained at the point B, whichever is smaller, is used.

Therefore, since, by setting the spreading rate to be 64 and by lowering data rate to 1/64, a spreading gain being about 18 dB can be obtained, communications can be made possible between the base station in the cell 1 having the SIR per one code being −6.4 dB shown in FIG. 6 and the terminal device being placed at the boundary point A. Moreover, by using a spreading gain and by performing code multiplexing, at a time, communications are made possible between the base station in the cell 1 and the terminal device being placed at the point B that can provide a better channel quality than the point A can.

Moreover, if communications are carried out with a terminal device being placed at a place where the SIR is sufficiently large without performing code multiplexing, radio communications are carried out by using the OFDM by selecting the spreading rate “p” being 1 in the spreading rate selecting section 203.

Therefore, as in the case of the first embodiment, in a place where the SIR is large, that is, channel quality is excellent, even in multipath environments, radio communications using the OFDM with degradation of its channel quality being reduced can be carried out. In a place where the SIR is small, that is, channel quality is poor, by applying a code spreading method and by selecting an optimum spreading rate according to the value of the SIR and to the number of code multiplexing and by lowering a data rate to 1/spreading rate to obtain a gain in code spreading, even when code multiplexing is performed, occurrence of a non-communicable area can be avoided and a high average throughput for the base station and the radio communication system can be achieved.

It is apparent that the present invention is not limited to the above embodiments but may be changed and modified without departing from the scope and spirit of the invention. For example, in each of the above embodiments, the radio transmitting and receiving devices are explained in which each of the base stations being placed at a vicinity of a center of each of the cells has the transmitting unit 101, 201 shown in FIG. 1A or FIG. 5A and each of the terminal devices performing transmitting and receiving of information with each of the base stations has the receiving unit 102, 202 as shown in FIG. 1B or FIG. 5B. However, each of the base stations may have both the transmitting unit 101, 201 and receiving unit 102, 202 shown in FIGS. 1A and 1B or FIGS. 5A and 5B and each of terminal devices may have both transmitting unit 101 or 201 and receiving unit 102 or 202 shown in FIGS. 1A and 1B or FIGS. 5A and 5B.

Moreover, in the above embodiments, the spreading rate is selected by using the SIR (or an SNR) and the number of code multiplexing as channel quality and data rate is switched depending on a value of the SIR (or the SNR) and the number of code multiplexing. However, the data rate can be more finely set by combining the above selecting method with a known method in which the data rate is switched based on a multi-leveling number during modulation, a coding rate, or a like.

Also, in the above embodiments, to select the spreading rate, predetermined expressions are used. However, the spreading rate may be changed, when necessary, according to specifications required in the radio communication system. For example, a plurality of predetermined threshold values is set to correspond to the channel quality information signal S_{IQL} and spreading rates corresponding to the threshold values are predetermined and a corresponding spreading rate according to a value of the SIR (or the SNR) may be selected. In this case, it is preferable that, as the value of the SIR (or the SNR) becomes smaller, larger spreading rate can by selected.

Furthermore, in the above embodiments, the SIR or SNR as channel quality to select the spreading rate is used. However, a ratio of a signal power to a sum of noise power and interference power may be used as the channel quality. In this case, a spreading rate may be selected in the same method as in the case where the above SIR or SNR is used.

What is claimed is:

1. A radio transmitting and receiving device comprising:
a transmitting unit to transmit radio signals, by using an orthogonal frequency division multiplexing method when channel quality exceeds a predetermined level, and by performing code spreading, using a spreading rate being preset so that, as said channel quality becomes degraded, a larger value as said spreading rate is selected, when said channel quality is less than said predetermined level; and
a receiving unit to demodulate received radio signals by detecting said channel quality from said received radio signals, by receiving radio signals using said orthogonal frequency division multiplexing method when said channel quality exceeds a predetermined level and by performing despreading by using a spreading rate selected by said transmitting unit when said channel quality is less than said predetermined level.

2. The radio transmitting and receiving device according to claim 1, wherein said receiving unit outputs information about a signal-to-noise ratio as said channel quality.

3. The radio transmitting and receiving device according to claim 1, wherein said receiving unit outputs information about a signal-to-interference ratio as said channel quality.

4. The radio transmitting and receiving device according to claim 1, wherein sa-Id receiving unit outputs information about a ratio of a signal power to a sum of noise power and interference power as said channel quality.

5. The radio transmitting and receiving device according to claim 1, wherein said transmitting unit has a spreading rate selecting section to select 1 (one) as said spreading rate when said channel quality exceeds said predetermined level and to select a spreading rate, being a power of 2, which is predetermined according to said channel quality when said channel quality is less than said predetermined level.

6. The radio transmitting and receiving device according to claim 1, wherein said transmitting unit performs code spreading on an axis of a frequency by using a selected spreading rate when said channel quality is less than said predetermined level and wherein said receiving unit performs despreading on an axis of a frequency by using said spreading rate when said channel quality is less than said predetermined level.

7. The radio transmitting and receiving device according to claim 1, wherein said transmitting unit performs code spreading on an axis of time by using a selected spreading rate when said channel quality is less than said predetermined level and wherein said receiving unit performs despreading on an axis of time by using said spreading rate when said channel quality is less than said predetermined level.

8. The radio transmitting and receiving device according to claim 1, wherein said transmitting unit, when performing code multiplexing by using two or more types of codes, selects a multiplied spreading rate obtained by multiplying a spreading rate, to be selected when said code multiplexing is not performed, by a number of types of codes to be multiplexed.

9. A radio communication system comprising:
a transmitting device to transmit radio signals, by using an orthogonal frequency division multiplexing method when channel quality exceeds a predetermined level, and by performing code spreading, using a spreading rate being preset so that, as said channel quality becomes degraded, a larger value as said spreading rate is selected, when said channel quality is less than said predetermined level; and
a receiving device to demodulate received radio signals by detecting said channel quality from said received radio signals, by receiving radio signals using said orthogonal frequency division multiplexing method when said channel quality exceeds a predetermined level and by performing despreading by using a spreading rate selected by said transmitting device when said channel quality is less than said predetermined level.

10. The radio transmitting and receiving device according to claim 9, wherein said receiving device outputs information about a signal-to-noise ratio as said channel quality.

11. The radio transmitting and receiving device according to claim 9, wherein said receiving device outputs information about a signal-to-interference ratio as said channel quality.

12. The radio transmitting and receiving device according to claim 9, wherein said receiving device outputs information about a ratio of a signal power to a sum of noise power and interference power as said channel quality.

13. The radio transmitting and receiving device according to claim 9, wherein said transmitting device has a spreading rate selecting section to select 1 (one) as said spreading rate when said channel quality exceeds said predetermined level and to select a spreading rate, being a power of2, which is predetermined according to said channel quality when said channel quality is less than said predetermined level.

14. The radio transmitting and receiving device according to claim 9, wherein said transmitting device performs code spreading on an axis of a frequency by using a selected spreading rate when said channel quality is less than said predetermined level and wherein said receiving device performs despreading on an axis of a frequency by using said spreading rate when said channel quality is less than said predetermined level.

15. The radio transmitting and receiving device according to claim 9, wherein said transmitting device performs code spreading on an axis of time by using a selected spreading rate when said channel quality is less than said predetermined level and wherein said receiving device performs despreading on an axis of time by using said spreading rate when said channel quality is less than said predetermined level.

16. The radio transmitting and receiving device according to claim 9, wherein said transmitting device, when performing code multiplexing by using two or more types of codes, selects a multiplied spreading rate obtained by multiplying a spreading rate, to be selected when said code multiplexing is not performed, by a number of types of codes to he multiplexed.

17. The radio communication system according to claim 9, wherein said transmitting device is placed in each of base stations, wherein said receiving device is placed in each of terminal devices to receive information from said base stations, and wherein multi-cells are constructed in one cell reuse manner in which all said base stations carry out radio communications with said terminal devices using same frequencies.

18. The radio communication system according to claim 9, wherein said transmitting device is placed in each of base stations, wherein said receiving device is placed in each of terminal devices to receive information from said base stations, and wherein multi-cells a reconstructed in H(Mis an integer being not less than 2) cell reuse manner in which all said base stations carry out radio communications with said terminal devices using M-types of frequencies.

19. The radio communication system according to claim 9, wherein said transmitting device is placed in each of base stations and each of terminal devices to receive information from said base stations, wherein said receiving device is placed in each of base stations and each of terminal devices, and wherein multi-cells are constructed in one cell reuse manner in which all said base stations carry out radio communications with said terminal devices by using same frequencies.

20. The radio communication system according to claim 9, wherein said transmitting device is placed in each of base stations and each of terminal devices to receive information from said base stations, wherein said receiving device is placed in each of base stations and each of terminal devices, and wherein multi-cells are constructed in M (M is an integer being not less than 2) cell reuse manner in which all said base stations carry out radio communications with said terminal devices by using M-types of frequencies.

21. A transmitting device being capable of transmitting radio signals in an orthogonal frequency division multiplexing method comprising:
an acquiring unit to acquire information about channel quality detected in a receiving device;
a spreading rate selecting unit to select 1 (one) as a spreading rate when said channel quality exceeds a predetermined level and to select a spreading rate being preset so that, as said channel quality becomes degraded, a larger value as said spreading rate is selected according to said channel quality when said channel quality is less than said predetermined level; and
a spreading unit to perform code spreading on transmitting signals by using said spreading rate selected by said spreading rate selecting unit.

22. The transmitting device according to claim 21, wherein said spreading unit performs code spreading on an axis of a frequency by using said spreading rate selected by said spreading rate selecting unit.

23. The transmitting device according to claim 21, wherein said spreading unit performs code spreading on an axis of time by using said spreading rate selected by said spreading rate selecting unit.

24. The transmitting device according to claim 21, wherein said spreading rate selecting unit, when performing code multiplexing by using two or more types of codes, selects a multiplied spreading rate obtained by multiplying a spreading rate, to be selected when said code multiplexing is not performed, by a number of types of codes to be multiplexed.

25. A receiving device being capable of demodulating radio signals transmitted according to an orthogonal frequency division multiplexing method comprising:
a channel quality estimating unit to detect channel quality from a received signal;
an acquiring unit to obtain a spreading rate selected by a transmitting device based on said channel quality; and
a despreading unit to perform despreading by using a spreading rate obtained from said transmitting device.

26. The receiving device according to claim 25, wherein said channel quality estimating unit outputs a signal-to-noise ratio as said channel quality.

27. The receiving device according to claim 25, wherein said channel quality estimating unit outputs a signal-to-interference ratio as said channel quality.

28. The receiving device according to claim 28, wherein said channel quality estimating unit outputs information about a ratio of a signal power to a sum of noise power and interference power as said channel quality.

29. The receiving device according to claim 25, wherein said despreading unit performs said despreading on an axis of a frequency by using said spreading rate obtained from said transmitting device.

30. The receiving device according to claim 25, wherein said despreading unit performs said despreading on an axis of time by using said spreading rate obtained from said transmitting device.

31. The receiving device according to claim 25, wherein said despreading unit, when said transmitting device performs code multiplexing by using two or more types of codes, acquires a number of multiplexing through said acquiring unit and performs said despreading using the obtained number of multiplexing.
